(19) United States
(12) Patent Application Publication
(10) Pub. No.: US 2008/0211906 A1
(43) Pub. Date: Sep. 4, 2008

(54) Intelligent Remote Multi-Communicating Surveillance System And Method

(76) Inventor: Ivan Lovric, Lunel (FR)

Correspondence Address: YOUNG & THOMPSON, 209 Madison Street, Suite 500, ALEXANDRIA, VA, 22314, US

(21) Appl. No.: 11/816,341

(22) PCT Filed: Feb. 3, 2006
(86) PCT No.: PCT/FR2006/000255

§ 371 Date: Aug. 15, 2007

(30) Foreign Application Priority Data
Feb. 16, 2005 (FR) 0501587
Jun. 30, 2005 (FR) 0506733

(51) Int. Cl. H04N 7/18

(52) U.S. Cl. 348/143; 348/E07.085

(57) ABSTRACT

The remote surveillance system contains:
at least two elements named “external network heads” containing, each one, at least:
   communication members at long distance.
   wireless communicating members at short range and.
   a microcontroller and
at least one sensor adapted to emit, with a wireless communicating member at short range, a signal representative of a physical data and the elements “external network heads” being adapted to communicate between them and with the sensor, via their wireless communicating members at short range, at least one of the elements “external network heads” being adapted to communicate at long distance, via its communication member at long distance, according to the state of each other element “network head” and according to the signal provided by at least one sensor.

The present invention relates to an intelligent remote communicating surveillance system and method. It applies, in particular, with the surveillance of buildings, children, old people and vehicles.

The current surveillance and security systems are completely centralized. The main control panel managed a certain number of detectors and communicates with the outside world. If the main control panel is destroyed or failing, the system becomes completely inoperative.

In the current state-of-the-art, two types of offers are proposed by the manufacturers. On the one hand, conventional systems, either wired or wireless, which require the intervention of an alarm installer. Their cost is expensive, their security and their intelligence depends only on only one main control panel, essential node of the system. Their intelligence and the level of security which they ensure are limited to only one main control panel. The security system which carries out the management of multiple and complex protocols is based on a completely dedicated design especially suited to each company.

On the other hand, a first generation of E-Surveillance products consisting mainly in WIFI cameras (acronym of Wireless Fidelity), which cannot be considered in the building domain as a security system coherent, complete and intelligent.

The majority of the initiatives in this field come from computer devices companies. They propose one type of security component (WIFI camera, WIFI microphone, WIFI siren) with embedded intelligence. It is likely that, in the short term, it will be possible to constitute basic security systems communicating with WIFI, and using internet. These expensive systems would never be complete, intelligent, multi-communicating and securized (they will depend on the WIFI radio band only).

The first two aspects of this invention aim at curing these disadvantages. To reach these goals, generally, according to its first aspect, the present invention consists of a remote surveillance system implementing an electronic network (system known as “E-surveillance”) in which several elements or components (detectors or sensors, for example) have an embedded intelligence localised in a microcontroller and a mean of communicating remotely. This surveillance system is able to be reorganized if at least one of the elements fails or becomes deteriorated.

Thus, according to its first aspect, the present invention aims at building a remote surveillance system, characterized in that it comprises:
at least two elements named “external network heads” comprising, each one, at least:
   a mean of communicating at long distance
   a mean of communicating without wire at short range and
   a microcontroller and
at least a sensor adapted to transmit, with a mean of wireless communication at short range, a signal representative of a physical data, the aforementioned elements “external network heads” being able to communicate between them and with the aforementioned sensor, via their means of wireless communication at short range, at least one of the aforesaid elements “external network heads” being adapted to communicate at long distance, via its mean of communication at long distance, according to the state of each other element “network head” and according to the signal provided by at least one sensor.

Thanks to these characteristics, if one of the elements “external network head” is out of order to communicate at long distance, another element “external network head” ensures the long-distance call.

For example, the surveillance system jointly exploits technologies of communicating at short range (for example Wifi, trademark) and at long distance, on electronic network (for example Internet). It can be also integrated simply into the domotic networks already in place.

Thus, the innovation lies in particular in the multiplication of the feature of “external network head”, within the surveillance system, taking into account that this feature may be integrated into all or part of the components of the system of security.

It is important to remark that the characteristics of the system which constitute the invention make the system easy to install, even when traditional security components are connected to it.

According to particular characteristics, at least one of the elements named “external network head” uses the data-processing protocol SNMP, acronym for Simple Network Management Protocol.

It is pointed out that this protocol makes it possible for the network administrators, to manage and supervise lots of data-processing equipments, and therefore is well suited for the management and supervision of a surveillance system.

According to particular characteristics, one or more wired sensors are directly connected to one of the elements named “external network head”.

According to particular characteristics, at least one of the elements named “network head” embeds a microphone-controller including its own power adapter. Thanks to these capabilities, each element can be miniaturized.

According to particular characteristics, the elements of the security system are divided into sets and, in each set, they can communicate with all the other elements of the aforesaid set. They are thus “intercommunicating”.

Thus, in term of performance and potential, the great force of the surveillance system resides, on the one hand, in its level of intelligence, the redundancy in several elements of the function “external network head” of the system, and in the fact that the elements of the security system are intercommunicating.

According to particular characteristics, in each set of elements, each element “network head” is adapted to become leader of the aforesaid set of elements, i.e. to organize the communications with all the other elements of the aforesaid set of elements.

Thus, in the event of failure of an element leader, another element, at least, is able to take over and to become the leader.

According to particular characteristics, at least two elements “external network head” process distinct communication base bands for long-distance calls. For example, communications on WIFI base band, and communications on GSM base band (acronym of Global Mobile System for Telecommunications) or UMTS (acronym of Mobile Universal Telecommunications System) can be processed by various elements “external network head”.

According to particular characteristics, at least one of the elements “network head” is adapted to cipher messages. For example 3DES ciphering (acronym of DIGITAL Encryption System) or AES (acronym of Advanced Encryption System) can be implemented.

According to particular characteristics, at least an element “external network head” is adapted to being accessed at long distance and, when it is accessed at long distance, to transmit a request to each other element “network head” of the system, and to receive, as response, the state and/or of the information collected by the aforesaid sensors of the other elements.

Thus, the system can be questioned, supervised or be managed at long distance, without any constraint of localization for the person or the system located remotely.

It is observed that the characteristics of the surveillance system make it easily upgradeable, modular and transportable, each addition of material being automatically integrated in the system. Moreover, the surveillance system can, thanks to these characteristics, be easily dismounted and transferred on another site, for example in the event of relocation of its user.

According to particular characteristics, each sensor is associated to a mean of communicating wirelessly at short range. Thanks to these capabilities, the installation of the surveillance system is simplified, the number of wires necessary being reduced thanks to the wireless communication at short range.

According to particular characteristics, each sensor is associated to a microcontroller. Thanks to these capabilities, the signal from the sensor can be treated locally, either to detect conditions of an alarm, or to transmit the signal, on external request.

According to particular characteristics, at least an element “external network head” is adapted to transmit an alarm remotely, according to a signal resulting from a sensor.

Thanks to these capabilities, a distant user can be immediately informed of the occurrence of conditions of an alarm.

According to particular characteristics, at least one element network head is adapted to remotely transmit a signal coming from a sensor.

Thanks to these capabilities, a distant user can be noticed and analyze the signal coming from the sensor, for example an audio signal and/or a video signal.

According to particular characteristics, at least a sensor is a sensor of image.

According to particular characteristics, at least a sensor is a sensor of sound waves.

According to particular characteristics, at least one sensor of sound wave is associated to a controller adapted to carry out a voice recognition.

According to particular characteristics, at least a sensor contains a pushbutton.

According to particular characteristics, at least one of the elements “external network head” is an ADSL and/or Wifi device ensuring remote connectivity to the Internet network.

According to particular characteristics, at least one of the elements network head comprises an interface with a telephone network and is adapted to dial a telephone number.

According to particular characteristics, at least one sensor is a perimetric and/or volumetric detector.

According to a second aspect, the present invention aims at building a process of remote surveillance, characterized in that it comprises:
a stage of capture and treatment of a physical data,
a stage of wireless communication at short range between an element named “network head” adapted to communicate at short range and another one among a plurality of elements named “external network heads” adapted to communicate at short range and at long distance,
a stage of long-distance call, carried out by one the elements named “external network head” according to the aforementioned wireless communication at short range.

The advantages, goals and particular characteristics of this process being identical to those of the surveillance system previously described, they are not pointed out hereafter.

The present invention relates also to an audio transmitter without wire at long distance. It applies, in particular, to the unidirectional transmission, for example for broadcasting and with the bidirectional transmission, for example telephony.

The wireless transmission resources at short range are used more and more. Among those, those implementing standard WIFI (acronym of Wireless-Fidelity or 802.11) have a considerable success and many portable computers and personal digital assistants (in English PDA) are equipped with this technology. However, the need for using a portable computer or a personal assistant to implement the Wifi standard makes this technology expensive when it is a necessary to carry out a simple function like radio-transmitting sound towards Internet at a low cost or when it is a necessary to carry out a simple telephone call towards a person connected to Internet at a low cost.

The wireless transmissions of sound are very common now in HF microphones, but their main disadvantage is to transmit sound modulated in frequency or amplitude, which makes them sensitive to radio jamming.

This disadvantage somewhat disappeared with the mobile phones. However it requires the purchase of a terminal at a cost sometimes expensive, and it is mandatory to subscribe to a mobile operator. Moreover, the transmitted sound cannot be sent towards Internet.

This issue has been somewhat solved with the arrival of the WIFI standard since several years. It is thus now possible to record an audio flow from a microphone connected to a computer or a personal assistant PDA and to transmit it towards Internet via a WIFI link, if the computer or the personal assistant PDA is equipped with a WIFI adapter.

The major disadvantage of this last solution is its high cost because it is necessary to have of a computer or a personal assistant PDA to transmit only sound. Moreover, the computer and the personal assistant PDA consume a lot of energy, which results in an accelerated discharge of the batteries and a weak autonomous operation for the system.

Some embedded solutions make it possible to transmit sound without the need for a computer or a personal assistant PDA. However they do not allow the use of traditional multimedia readers like RealPlayer (trademark) or QuickTime (trademark) to listen to the sound.

The third aspect of this invention aims at curing these disadvantages. It proposes an “audio/Wifi/Internet transmitter” unidirectional or bidirectional, to meet the need to transmit sound by radio using Wifi technologies and to be able to listen to this digitized sound from Internet. The achievement of a transmitter according to the third aspect of this invention also aims at being cheap and compact (for example a volume hardly higher than the volume of a classical HF microphone) and at consuming a little amount of energy.

The wireless transmissions of sound are now very classical in the cordless phones of type DECT (acronym of DIGITAL Enhanced Cordless Telephony) or GSM. But their principal disadvantage is to use protocols not compliant with Internet.

According to its third aspect, the present invention aims at building a wireless transmitter, characterized in that it comprises:
a sensor of sounds,
a transmitter at short range and
an electronic circuit containing a single integrated circuit consisting in a reprogrammable microcontroller able to implement a standard of wireless communication at short range to transmit packets of data organized in transmission of standardized data flows to an access point, according to a communications protocol on the aforementioned data-processing network.

Thanks to these capabilities, since the electronic circuit contains a single integrated circuit, its design, its manufacture and its setting implementation are simplified and are cost-effective, with a little volume and weight. Moreover, since the microcontroller is reprogrammable, the transmitter can evolve and implement programs which are different according to the configuration hardware and software and according to user's needs. For example, preprocessing can be carried out on the signals collected by the sensor of sounds. Moreover, as a reprogrammable component, it is a component standard on the market and its price is weaker than a specific component, with identical calculation capabilities.

For example, the standard of communication at short range is the Wifi standard, the transmission of data flow implements the standard RTSP (acronym of Real Time Streaming Protocol) and the communications protocol on a data-processing network is “IP” for Internet Protocol.

Thanks to these capabilities, the transmitter, which embeds the stack of Internet protocols and the resources for transmitting the data flows (streaming RTSP), makes possible the use of standard multimedia readers of type RealPlayer type to listen to the sound.

According to an alternative of its third aspect, the present invention aims a building a Wifi/Internet phone using a microcontroller on a printed circuit board to meet the need to transmit and receive sound in full duplex on Internet by radio using technologies of voice over IP and Wifi embedded in a standard microcontroller and largely deployed, for example of family MICROCHIP (trademark). The use of a standard microcontroller guarantees the evolutivity of the solution. The microcontrollers are increasingly powerful and incorporate more and more functions (RAM, ROM, EEPROM, analogic/numeric and numeric/analogic conversion). Each aspect of this invention thus takes benefit from this power and this integration to obtain a unit miniaturized, cheap, and low power consuming.

Thus, according to particular characteristics, the reprogrammable microcontroller contains an output of audio signals intended to be transmitted by an electroacoustic transducer and the reprogrammable microcontroller is adapted to implement a standard of communication to short range to receive packets of data organized in transmission of standardized data flow from the aforementioned access point connected to a data-processing network, according to a communication protocol on the aforementioned data-processing network.

Thanks to these capabilities, the transmitter can be bidirectional and act as cordless phone on Internet.

According to particular characteristics, the reprogrammable microcontroller controls a Wifi adapter with a PCMCIA interface or Personal Computer Memory Card International Association defined by the International association of the memory boards for micro-computer or a Compact Flash adapter.

Thanks to these capabilities, the Wifi adapter has a weak complexity and cost and is easy to connect.

According to particular characteristics, the reprogrammable microcontroller implements the protocol of realtime flow over Internet RTSP, or Real Time Streaming Protocol.

According to particular characteristics, the reprogrammable microcontroller implements the Protocol of RealTime Control over Internet RTP/RTCP, or Real Time Protocol/Real Time Control Protocol.

Thanks to each one of these capabilities, compatibility with Internet standards and multimedia make it possible for the recipient to diffuse the audio signal with simple multimedia readers such as RealPlayer and QuickTime rather than with proprietary softwares, which would have been the case if standard protocols had not been used.

Moreover, this implementation is done with few components.

According to particular characteristics, the sensor of sounds is connected to an analogical entry of the reprogrammable microcontroller.

Thanks to these capabilities, one avoids the need for an external digitizer with the microcontroller and the complexity of realization which would result from it.

According to particular characteristics, the reprogrammable microcontroller implements ARP or Address Resolution Protocol.

According to particular characteristics, the reprogrammable microcontroller implements IP or Internet Protocol.

According to particular characteristics, the reprogrammable microcontroller implements UDP, or Universal Datagram Protocol.

According to particular characteristics, the reprogrammable microcontroller implements TCP, or Transmission Control Protocol.

According to particular characteristics, the reprogrammable microcontroller implements the protocol of voice over IP using the H323 standard.

Thanks to each one of these capabilities, the signal transmitted or received by the transmitter object of the third aspect of this invention can be exchanged with systems implementing these standard protocols. In particular, compatibility with multimedia internet standards make it possible to implement the third aspect of this invention with softwares implementing the largely deployed H323 standard such as “Netmeeting” and “Openphone” (trademarks) rather than with proprietary softwares, which would have been the case if standardized protocols had not been used.

According to particular characteristics, the reprogrammable microcontroller contains an output interface using pulse modulation connected to a low-pass filter and implements this interface to emit an audio signal.

Thanks to these capabilities, the emission part of audio signals is simple, not very expensive and reliable.

According to particular characteristics, the reprogrammable microcontroller implements an adaptation of a codec 16 bits for a sampling on 8 bits.

For example, the codec considered is the codec PCM-uLaw. Thanks to these capabilities, a simpler microcontroller, of lower cost, for example with limited capabilities for encoding/decoding to eight or ten bits, can be used.

Other advantages, goals and characteristic of the invention will come out from the description which will follow, with an aim at being explanatory and by no means restrictive, with references to the annexed drawings in which:

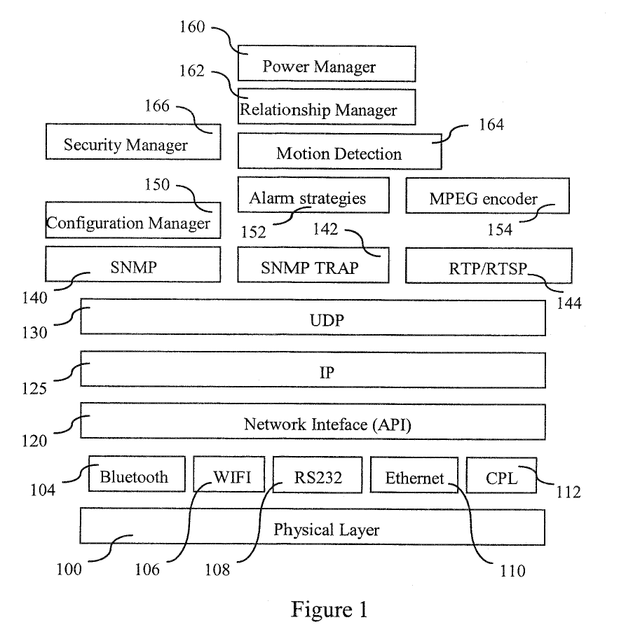

FIG. 1 represents the OSI model (networks layers) of a particular mode of realization of the surveillance system object of the first aspect of this invention,

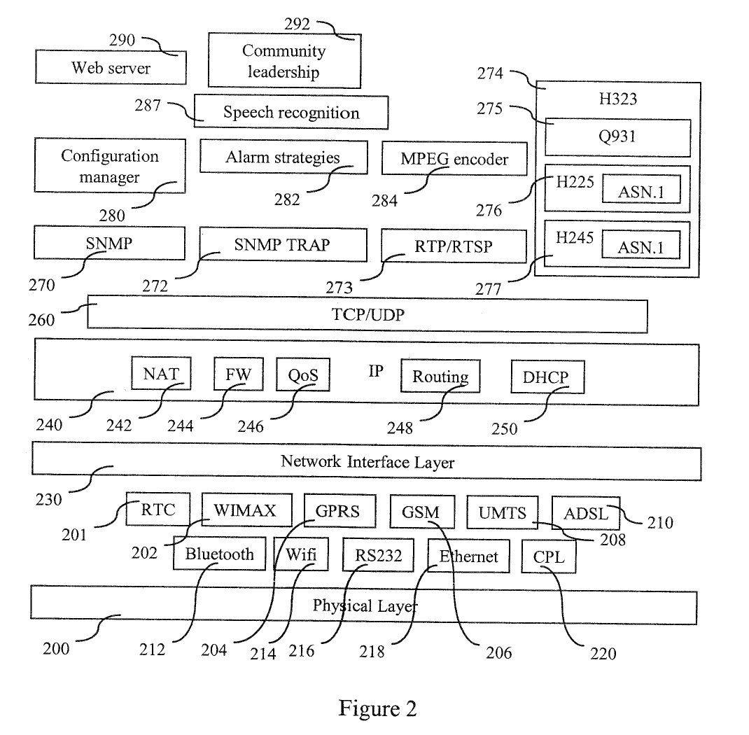

FIG. 2 represents the OSI model of a particular mode of realization of the surveillance system illustrated in FIG. 1 and also using the layer network interfaces to reach in particular other networks of the type ADSL and UMTS,

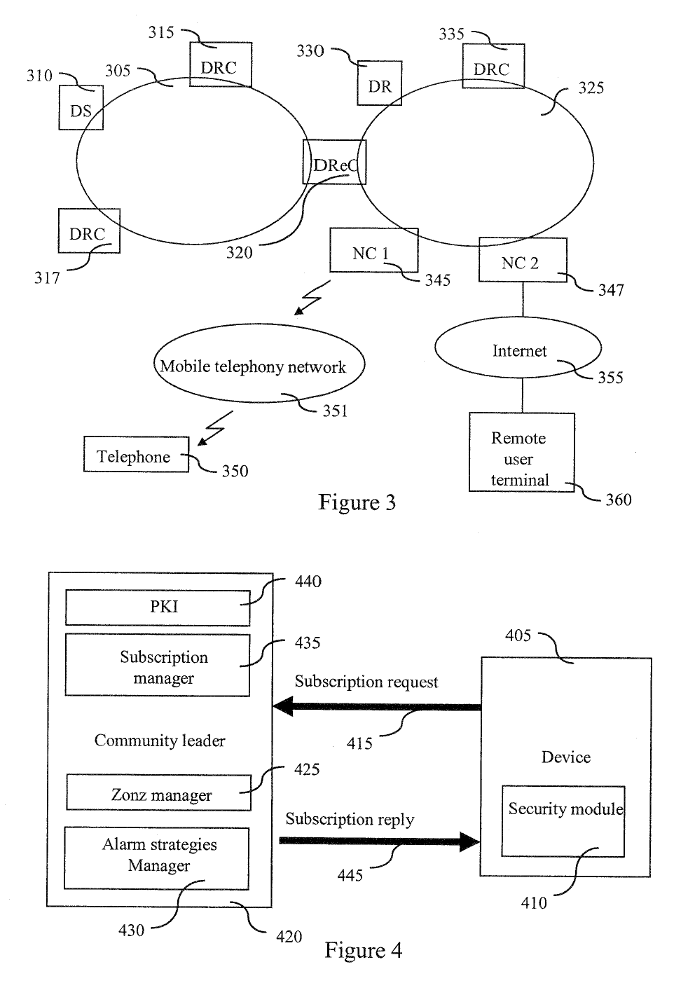

FIG. 3 represents, schematically, relationships between elements of a particular mode of realization of a surveillance system in conformity with the first aspect of this invention, distributed into several supervised zones,

FIG. 4 represents, schematically, the management of a community of elements constituting a mode of realization of a surveillance system in conformity with the first aspect of this invention,

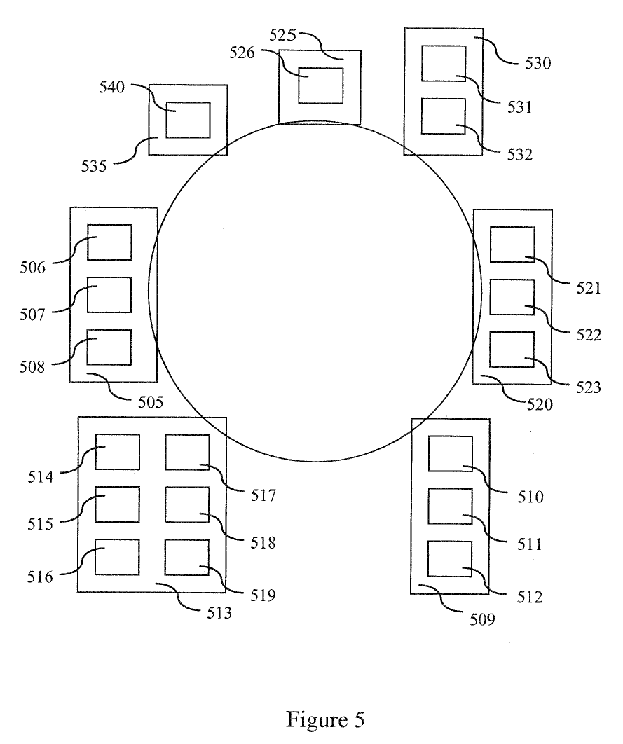

FIG. 5 represents, schematically, a particular mode of realization of the surveillance system object of the first aspect of this invention,

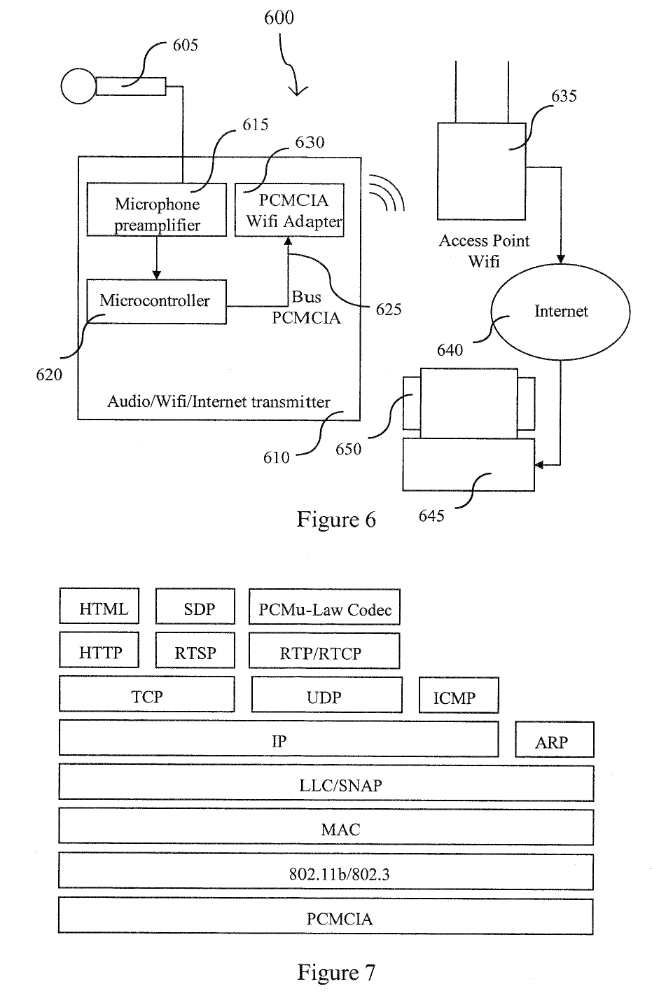

FIG. 6 represents, schematically, a first mode of realization of the third aspect of this invention in the form of an unidirectional audio transmitter,

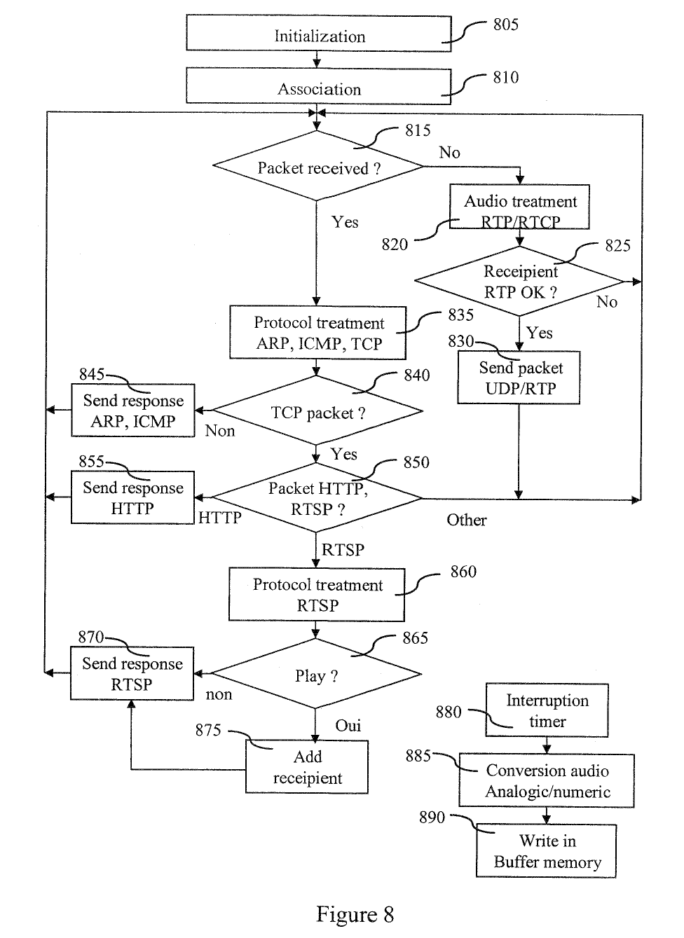

FIG. 7 represents protocol layers implemented by the first mode of realization of the third aspect of this invention illustrated in FIG. 6,

FIG. 8 represents, in the form of a logigramme, the stages implemented by the first mode of realization of the third aspect of this invention illustrated in FIGS. 6 and 7,

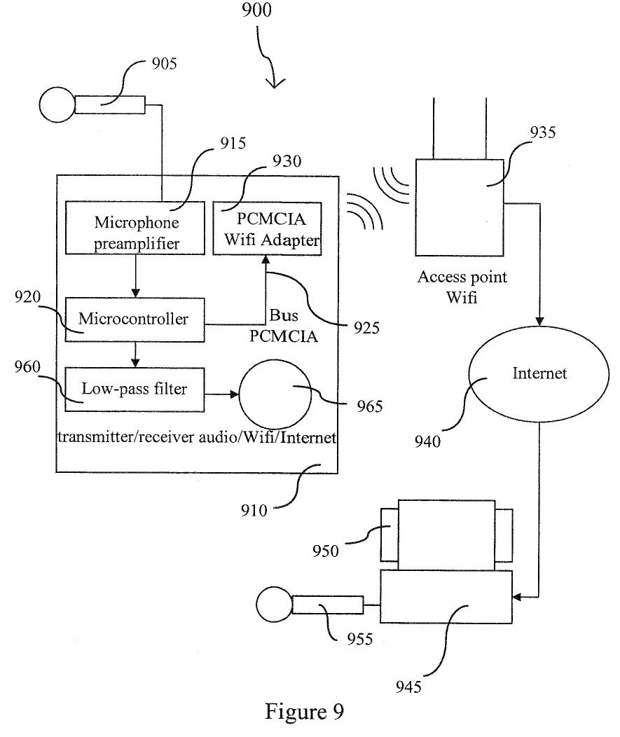

FIG. 9 represents, schematically, a second mode of realization of the third aspect of this invention in the form of a bidirectional audio transmitter,

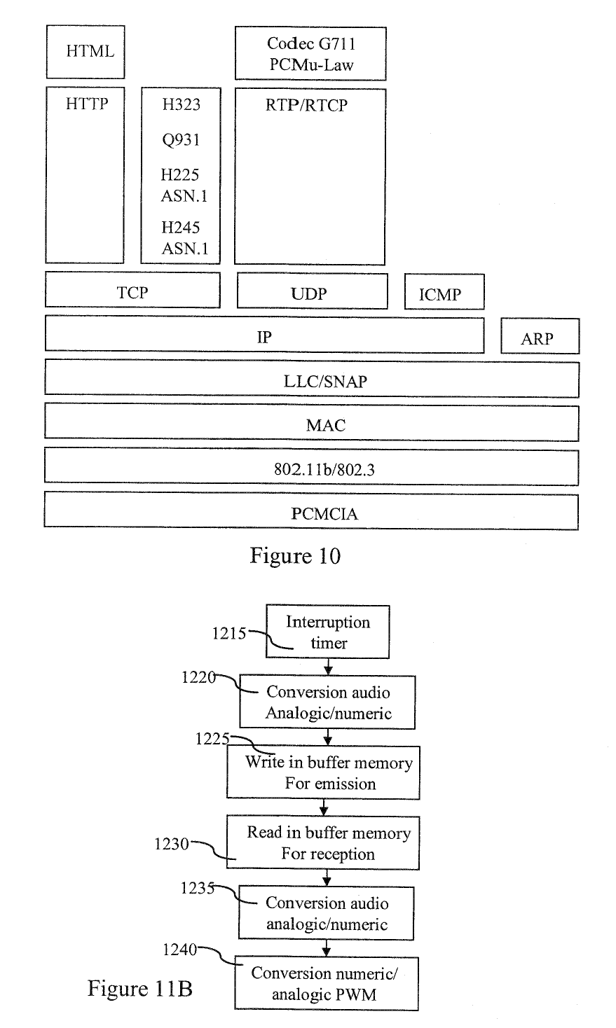

FIG. 10 represents protocol layers implemented by the second mode of realization of the third aspect of this invention, illustrated in FIG. 9 and

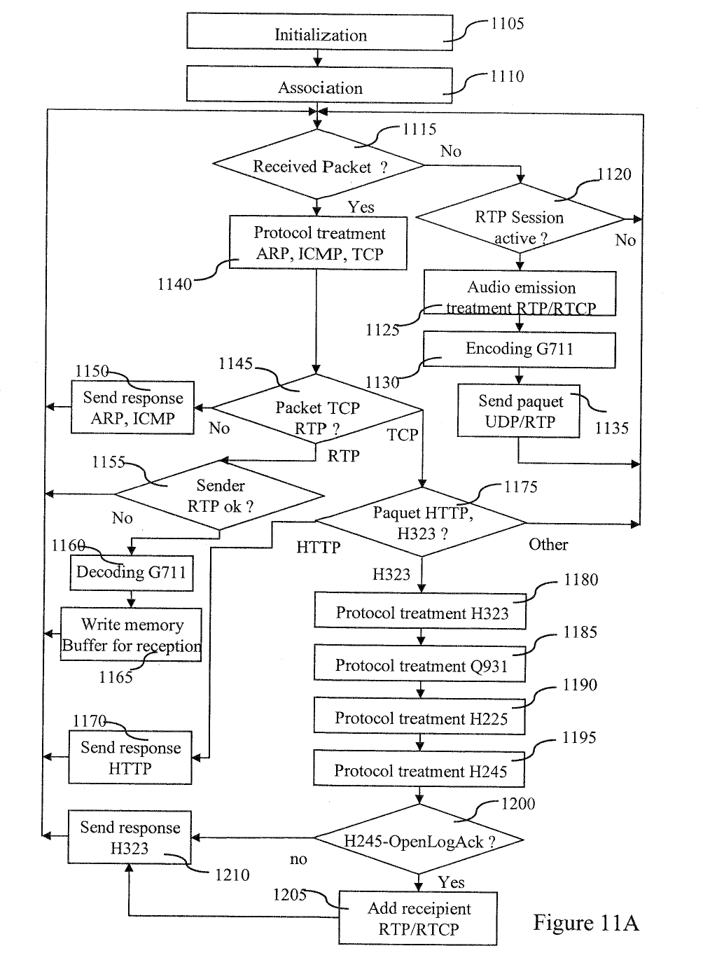

the FIGS. 11A and 11B represent, in the form of a logigramme, the stages implemented by the second mode of realization of the third aspect of this invention illustrated in FIGS. 9 and 10.

In all description, the terms “element”, “equipment” and “component” cover the same objects which are parts of a global security and surveillance system.

In the mode of realization of the surveillance system object of the first aspect of this invention which is described in FIGS. 1 to 5, in particular in FIG. 5, each element of the system contains an intelligent electronic module with multicommunicating capabilities. This electronic module which manages the element has an embedded intelligence in a microcontroller and is adapted to communicate with several other modules and, possibly, at long distance. In this last case, the element is known as “external network head”. For example, the protocols of communication which it implements are part of the following protocols: UMTS, GSM, GPRS, WIFI, WIMAX and BLUETOOTH. If the element has only capacities of communication at short range, the element is known as “network head”.

The operating system implemented by each module is, for example, ucLinux and the embedded software applications integrate all the functions of management and monitoring of a security control panel, all the wireless communications protocols, all the modules for domotic connection and automation and interfaces for the integration of communications adapters.

Each module can be connected to each standardized component of a security and surveillance system, for example all types of cameras, microphones, alarm, detectors of intrusion, fire detectors, pushbuttons . . .

This standardized module allows the composition of an electronic surveillance and security system of new generation. It has the following advantages:
it is equipped with an unequalled level of intelligence,
it can be installed by all types of public, in particular because it implements communications on wireless links,
its parameter settings can be automatic as soon as the module is connected to a power supply,
it is evolutionary, modular and transportable,
it can be consulted and parameterized remotely, via computers connected to the public switching telephone network with a modem, possibly via WIFI or via a mobile phone,
it is completely protected: for example, it communicates on a mobile telephony network in the event of loss of communications on a wired telephony network. Moreover, the total intelligence is ensured by each module of the system,
all the modules are inter-communicating.

In alternatives, each module integrates artificial intelligence (form recognition, voice recognition, automatic generation of new strategies of security by neural networks or expert systems).

In alternatives, one can implement several versions of the module, in a logic of trade and economic optimization. For example, in alternatives, one implements two specific modules, one intended for audio and video signal processing and the other for the management of detectors or pushbuttons providing a binary signal. The design of these two modules would make it possible to optimize the weight of the power adapter and the domotic interfaces for house automation, and therefore to reduce the total cost of the system.

This second module could also be integrated inside a portable audio pushbutton in order to contribute to the development of the market of the remote surveillance for the ageing people, children or patients. This portable audio pushbutton is an emergency button for the old or sick people: in the event of fall, the user presses on the button and alarm is given remotely; according to alternatives, the user can also speak to describe his problem and/or to receive sound and thus to discuss with his remote interlocutor.

The architecture of the surveillance system, the integration of technologies of communication and the proposed services take part in the implementation of the first aspect of this invention.

It is observed that the supervision of a room or a house, is very similar to the supervision of a data-processing network. Indeed, the various elements of a security system (perimetric sensor, siren, detector, camera . . . ) behave as nodes of a network.

For the implementation of the first aspect of this invention, the reader will be able to choose the protocol SNMP (acronym of Simple Network Management Protocol) as protocol Internet applied to the management of a security system.

Preferentially, the surveillance system object of the first aspect of this invention implements this protocol for the administration and the management of alarms raised by each node of the network of alarm of the house or company.

Protocol SNMP can be supported natively by other equipments of the domotic network (game console, refrigerator . . . ). All these equipments are then ready to be managed in the network and to generate alarms in the case of malfunction. Thus, the video surveillance and security system based on protocol SNMP, can be easily integrated in a domotic network.

FIG. 1 represents the OSI model (networks layers) of an equipment of surveillance in conformity with the first aspect of this invention and using protocol SNMP to send alarms and to be managed and supervised remotely.

It is observed, in FIG. 1, on the basis of the physical layer 100, that the standards Bluetooth (trademark) (stack of protocols for the point-to-point radio communication at short distance between data-processing peripherals) 104, Wifi (acronym of Wireless Fidelity) 106, RS2332 108, Ethernet (trademark) 110 and CPL (Powerline Networking) 112 can be implemented by the surveillance system.

Some of these standards are adapted to the communication at short range, for example Bluetooth 104 and Wifi 106. Others are adapted to the communication on a local area network, for example Ethernet 110. RS232 is only useful to configure the terminal in console mode, which can be useful for an alarm installer but not for a user.

The PowerLine Networking makes it possible to communicate with elements connected to the domotic power outlets, which constitutes an alternative to the wireless communication. The Powerline Networking is rather often used in house automation.

Then, one finds the Network Interface layer 120, which makes it possible for the equipment to connect to the network, and a layer of Internet Protocol 125.

Then, a layer UDP (acronym of Universal Datagram Protocol) 130 (It acts as a standard protocol of exchanges of packets on Internet without control of flow). Then, in the following layer, SNMP (acronym of Simple Network Management Protocol) 140, SNMP TRAP (Protocol of sending of alarms SNMP) 142 and RTP/RTSP (Real Time Protocol, Real Time Streaming Protocol or multimedia Protocol) 144 carry out the supervision of the modules and the management of alarms, as well as the management of multimedia flows coming from the microphones and cameras.

Then, in the following layer:
the configuration manager 150 “configuration manager” manages the configuration of the element;
the manager of alarm strategies 152 implements one or more alarm strategies and
MPEG encoder 154 carries out the encoding of images animated with MPEG format.

Lastly, in last layer, are the power manager 160, the relationship manager 162, the motion detector 164 detects movements, for example by comparing the images from the cameras between two intervals of time and the security manager 166 which manages the security within flows of internal and external information of the security system, in particular ciphering and authentication between the modules.

FIG. 2 represents the OSI model of a node of external communication also using the network interface layer to reach in particular other networks of type ADSL and UMTS.

It is observed, in FIG. 2, on the basis of the physical layer 200, that standards like PSTN (Public Switching Telephone Network) 201, Wimax (Worldwide Interoperability of Microwave Access) 202, GPRS (acronym of General Packet Radio Service) 204, GSM (Global System for Mobile Telecommunications) 206, UMTS Universal Mobile System Telecommunications) 208, ADSL (asymmetric DIGITAL Subscriber Line) 210, Bluetooth (trademark) 212, Wifi 214, RS2332 216, Ethernet (trademark) 218 and CPL (Powerline Networking) 220 can be implemented by the surveillance system. These elements of the same layer are represented on two different lines, for commodity reasons but correspond to the same layer of protocols.

Some of these standards are adapted to the communication at short range, for example Bluetooth 212 and Wifi 214. Others are adapted to the communication on telephone network, for example GPRS 204, GSM 206 and UMTS 208. Others are adapted to the communication on local area network, for example Ethernet 218 and others are adapted to the remote communication of information data implementing the internet protocol TCP/IP (Transmission Control Protocol/Internet Protocol), for example ADSL 210. Wimax is an extension of Wifi allowing the transmissions on greater ranges.

To the top of the physical layer 210, and layer of network interface 230, a layer of Internet Protocol IP 240 is adapted to implement NAT functions (acronym of Network Address Translation) 242, FW (acronym of Firewall) 244, QoS (acronym of quality of service) 246, Routing (routing of internet packets) 248 and DHCP (acronym of Dynamic Host Configuration Protocol) 250.

Above the layer IP 240 is a layer TCP/UDP (acronym of Transmission Control Protocol/Universal Datagram Protocol) 260 (These are standard protocols of exchanges of packets on Internet with or without flow control). Then, in the following layer, SNMP (acronym of Simple Network Management Protocol) 270, SNMP TRAP (Protocol for sending SNMP alarms) 272, RTP/RTSP (Real Time Protocol, Real Time Streaming Protocol) 273 and H323 274 for the stack of protocol of voice over IP which includes:
Q931 275,
H225 with encoding ASN.1 PER 276,
H245 with encoding ASN.1 PER 277.

These layers 270 to 277 carry out the supervision of the modules and the management of alarms, as well as the management of multimedia flows coming from the microphones and cameras.

Then, in the following layer:
the configuration manager 280 “configuration manager” manages the configuration of the local area network in which the element is inserted;
the manager of alarm strategies 282 implements one or more alarm strategies and
MPEG encoder 284 carries out the encoding of images animated with MPEG format.

Lastly, in the last layer, are the Web server 290, which communicates remotely like any internet Website and provides a remote user with a Website in order to be informed of the state of the surveillance system and the result of the data processing from the sensors, and the community leadership 292 which manages the takeover and the animation of the community.

In terms of services, the security equipments are integrated in a dynamic zone named security community. The community contains several physical zones which can cover different spaces (room, house, allotment . . . ) and which define sets of elements able to communicate between them. The security equipments are integrated in this community in a dynamic way after a process of subscription via a Web site during which are examined the following points:
technical capabilities of the equipment,
functional capacities of the equipment and
rights of the equipment in the security community.

The equipment “leader” of the community then decides the role of the new equipment in the community, and the security rights which will be affected to it . The decision takes place by modifying the security strategies in order to add the new equipment and to specify its role. The upgrade of the strategy takes place from the Web site of the community leader where all the interactions between the components are specified.

Then the community leader issues a new certificate of security to the new equipment (by carrying out an internal request with the registration manager). This certificate being in conformity with the PKI (Public Key Infrastructure) of the security system, the new equipment will be able to cipher and decipher the messages in the security community.

Then, an exchange of certificates of security ensures the coding of the future exchanges between the equipment and the other members of the community. These certificates can be with symmetric keys or asymmetrical keys.

The equipment community leader is managed from a Web site, but has a default configuration which allows it automatically to accept equipments offering the required guarantees in terms of security compliant with the predefined security strategies.

According to technical capabilities of the customer equipment, security strategies are downloaded inside the equipment itself, which then allows it to know in which way the stimuli from the sensors have to be dealt with, and how to communicate with the neighbouring equipments in the zone of security.

A preferential mode of realization of the surveillance system object of the first aspect of this invention combines technologies of telecommunications, video, micro-electronics, and data processing.

Indeed, the networks supports are multiple (UMTS, ADSL, Wifi . . . ) and are interfaced with each equipment of the security system via a network interface. This interface can manage the great diversity of the network supports and communicate with the higher layers of service thanks to TCP/IP and UDP sockets.

Then, the operating system of the equipment manages the video encoding. Coding during the exchanges with the other “network head” elements is ensured by the security manager.

Micro-electronics allows simultaneously the integration of the software components of the operating system uCLinux (trademark) on a microcontroller of the DragonBall type (trademark) or ATMEL (trademark), the management of the sensors of security (video or any other type) by the community leader associated with the strategies of security, and the control of the power adapter of the alarm module by the power manager.

The programming also intervenes in the modules of advanced services illustrated in FIGS. 1 and 2, such as a manager of strategies “Strategies Manager”, the website 290 “Web server”, the manager of the community 292 “Community Leadership”, the detector of movement 164 “Motion detection” and a module of voice recognition “Speech Recognition” 287. Preferentially, each micro-module contains an integrated microphone able to recognize numbers, thus it is possible to be authenticated by alphanumeric code by pronouncing a sequence of numbers, words or a predefined sentence.

The structure of the surveillance system is based on devices equipped with a Wifi interface having each one a specific role, for example:
Static detector (DS) (connected by wired way to a communicating detector or a node of external communication); it acts for instance as a magnetic contact toggling when a door opens
reconfigurable static detector (DR.), for example detector being able to be reconfigured remotely (connected by wired way to a communicating detector or a node of external communication); it acts for example as a passive infrared detector with a sensitivity which can be modified.
reconfigurable communicating detector (DRC), for example detector being able to communicate with other equipments,
communicating detector gateway (DReC), for example detector being able to route information between several zones,
Video detector MPEG (FD) which ensures the encoding of the videos and the streaming (transmission of video flows),
Audio Detector (DA) which ensures the encoding of the sound and the streaming (transmission of audio flows),
module of artificial intelligence (MIA) which ensures the voice recognition or the form recognition in an image, according to the type of detector with which it is associated,
node of external Communication (NC) or element “external network head”, which ensures the interconnection with the external world.

Any communicating detector is an element of type “network head”.

The detectors are placed in communities of security described hereafter. The communities of security share an IP network of security with multiple zones. The peripherals previously described are placed in the various zones of security and communicate between them and with the nodes of external communication according to their technical capabilities and parameter settings defined in the security strategies.

One observes, in FIG. 3, an example of system in conformity with the first aspect of this invention. It comprises two zones or sets of elements 305 and 325, a phone 350, the Internet network 355 and a distant terminal 360 connected to the Internet network 355. The first zone 305 is provided with a Static Detector (DS) 310 and with two reconfigurable communicating detectors (DRC) 315 and 317. A communicating detector gateway (DReC) 320 connects the zones 305 and 325. The zone 325 is provided with a reconfigurable detector (DR.) 330, with a reconfigurable communicating detector (DRC) 335, and with two nodes of external communication (NC1 and NC2) 345 and 347. The node of external communication 345 connects the surveillance system to the phone 350 via a mobile phone network 351. The node of external communication 347 connects the surveillance system to the Internet network 355 and, therefore, to the remote user terminal 360.

Before being able to join a security community, a peripheral must be initially validated by the leader of the community. The peripherals not having a module of security have restricted rights within the community. After inscription of new equipment, the leader informs all of the members of the community of the arrival of this new equipment in order to update the security strategies.

As observed in FIG. 4, the peripheral 405, which implements a module of security 410, transmits initially a request of subscription 415 to the leader of the community 420, which can be a node of external communication or a detector, for example. The community leader 420 implements a manager of zones 425, a manager of security strategies 430, a subscription manager 435 and one memory containing the asymmetrical key certificates of the PKI 440.

In response to a request 415, the community leader 420 sends a subscription reply 445 to the device 405.

The IP network of security implements various classes of services

| Class | Level of priority |
|---|---|
| Alarm TRAP (SNMP TRAP) | 20 |
| Alarm Config (SNMP Supervision) | 18 |
| Videosurveillance | 16 |
| Voice over IP | 14 |
| Video Streaming HQ (High Quality) | 12 |
| Data | 10 |
| Standard Video Streaming | 8 |

The priority is given to the services of security, but these services generally occupy a little bandwidth, thus the IP network can be used for other classes of service. It is then possible to use the network of security to route flows needed for domotic use automation such as voice over IP, video, phone voice, etc . . .

One observes, in FIG. 5, a remote surveillance system 500, which comprises:
an element “external network head”, or node of external communication, 505 including:
   a mean of communicating at long distance 506
   a mean of wireless communicating at short range 507 and
   a microcontroller 508;
an element “external network head”, or node of external communication, 509 including:
   a mean of communicating at long distance 510
   a mean of wireless communicating at short range 511 and
   a microcontroller 512;
an element “external network head”, or node of external communication, 513 including:
   a mean of communicating at long distance 514
   a mean of wireless communicating at short range 515 and
   a microcontroller 516;
   a sensor of image 517;
   a sensor of sounds 518 and
   a fire detector 519 providing a binary signal;
a reconfigurable detector 520 comprising a microphone 521, a microcontroller 522 and one mean of wireless communicating at short range 523;
a static detector 525 comprising an infrared sensor 526;
a static detector 530 comprising a sensor of intrusion 531, a microcontroller 532 and
a transmitter of infrared signals 535 with pushbutton 540.

It is supposed that all the means of communicating at short range implement the Wifi standard.

The element “external network head” 505 is, for example, a Wifi access point. The mean of communicating at long distance 506 is, for example, an ADSL modem. Microcontroller 508 stores in memory and implements the software modules described in FIGS. 1 to 4. By default, the element “external network head” 505 is the element leader of the community of elements illustrated in FIG. 5.

The mean of communicating at long distance 511 is, for example, a low bandwidth modem. Microcontroller 513 stores in memory and implements the software modules described in FIGS. 1 to 4. By default, the element network head 510 is not the element leader of the community of elements illustrated in FIG. 5 but becomes it in the event of failure of the element “external network head” 505.

The mean of communicating at long distance 516 is, for example, a module of communication on the mobile phone network. Microcontroller 518 stores in memory and implements the software modules described in FIGS. 1 to 4 and, in particular, the module of MPEG format encoding, used to encode the images collected by the sensor of image 519, when a long-distance call was established with the surveillance system 500.

By default, the element “external network head” 515 is not the element leader of the community of elements illustrated in FIG. 5 but becomes it in the event of failure of the two elements “external network head” 505 and 510.

Microcontrollers 522 and 532 store in memory and implement the software modules described in FIGS. 1 to 4, except for those related to the long-distance calls and the management of the community.

The infra-red sensor 526 is adapted to detect the signals emitted by the infra-red emitter 535 when a user activates the pushbutton 540.

The sensor of intrusion 531 has a standard type, for example a volumetric or perimetric detector.

By default, the various elements of the surveillance system function in a mode named “infrastructure”, in which all the elements communicate only with the community leader.

In the event of failure of the leader, the other elements automatically switch to “adhoc” mode in which, they communicate all between them.

Thus, the elements “network heads” are adapted to communicate between them and with each detector or sensor, via their means of wireless communicating at short range.

At least one of the elements “external network heads” is adapted to communicate at long distance, via its mean of communicating at long distance, according to the state of each other element “network head” and according to the signal provided by at least one sensor.

For example, the element “external network head” 510 communicates at long distance when the element “external network head” 505 is failing (element 510 detects this malfunction when it does not succeed in communicating with element 505) and the element “external network head” 515 communicates at long distance when the elements “external network head” 505 and 510 are failing.

The long-distance call is established, either on the initiative of the surveillance system (in the event of detection of a predefined event like, for example, an activation of the pushbutton 540, the detection of an intrusion or the speech recognition of a “SOS” collected by the microphone), or on the initiative of a distant actor, for example, by accessing the Web server either of the element “external network head” 505 or of the element “external network head” 510, or by phone call using the mean of communicating at long range 516.

It is observed that, among the sensors with which the intelligent electronic multicommunicating module can be associated, are:
perimetric detectors,
magnetic contacts,
detectors of shocks . . .
Volumetric detectors:
   with radars,
   with infra-red . . .
fire detectors, flood . . . ,
Video cameras and
microphones.

The system can also be connected, locally with one or more sirens, loudspeakers, flash lights, for example, to warn the residents of the occurrence of a predetermined event detected by one of the modules, by activation of the strategy of security chosen by the user.

With regard to the procedure of selection of the module of “external network head” implemented to communicate remotely, a strategy of security “CommunicationPriority” establishes the level of priority for the local and remote calls.

Each module has a single identifier (MAC address) and the strategy of security contains a table with the following fields:

| | | “local | “distant |
|---|---|---|---|
| “Module Identifier” | “Name” | Priority comm” | Priority comm” |
| 0a:ab:cd:12:34:56 | Camera1 | 100 | 70 |
| 0a:ab:cd:12:34:57 | Microphone1 | 90 | 80 |
| 0a:ab:cd:12:34:58 | Siren1-GSM | 80 | 90 |
| 0a:ab:cd:12:34:59 | PIR1-PSTN | 70 | 100 |
| 0a:ab:cd:12:34:60 | PIR2 | 60 | 60 |

In this example, the community leader is the module “Camera1” which has the maximum priority in local call; if it had suddenly been failing, the module “Microphone1” would take over as the community leader.

The distant communication is firstly the PSTN with module PIR1, and then comes the GSM. All the other modules still have the possibility of communicating by Internet if modules GSM and PSTN were failing.

It is observed that nothing prevents from having several different strategies “communication” which are activated according to various criteria like the calendar, the mode of alarm, total or restricted . . .

With regard to the procedure of detection of the failure of a module, the community leader periodically sends requests of supervision SNMP towards each member of the community to obtain information on their operating condition.

Each module has a MIB (Management Information Base) SNMP which characterizes it. Thus, a module with Passive Infra-red (PIR) with capacity of communication PSTN, will have a MIB different from a module with Microphone.

For example the MIB of module “PIR1-PSTN” will contain the following info:
State of PSTN line: Deactivated, Activated, Not linked,
State of the batteries: Full, Medium, or Weak,
State of detector PIR: Deactivated, Activated, Chime,
last Date/time alarms: Apr. 12, 2005, 11:36,
a number of alarms since the activation of the system: 3 . . .

The leader of the community can decide to deactivate or modify the behaviour of certain sensors according to the parameter settings of the security strategies.

In the previous example, the community leader can, for example, decide that detector PIR will be in chime mode between 10:00 and 12:00, meaning that the siren emits a noise of chime when somebody enters in this room at 11:00 for instance.

With regard to the procedure of security management applied by the community leader to the other modules:

The security strategies are duplicated in all the modules, which makes it possible for the system to be reorganized in the event of failure of the leader or any other module.

The mode of recombining for the communication is defined in the strategy “CommunicationPriority”.

A strategy of security uses a macro language describing the interactions between the sensors:

For example:

```
Strategy “MotionDetection”
If Camera1.MotionDetected
  If Hour >10:00 and Hour <17:00
    Microphone1. AskAuthentification
    If Microphone1. AuthentificationOk
      Siren1-GSM.Chime
    Else
      Siren1-GSM.Ring
      LaunchDistantCommunicationAlarm
    End
    Exception (Microphone1 does not answer the order, it is
    perhaps failing)
    if PIR2.MotionDetected
      Siren1-GSM.Ring
      LaunchDistantCommunicationAlarm
    Else
      LaunchDistantCommunicationAlarmFailure(Microphone1)
    End
  Else
    Siren-GSM.Ring
    LaunchDistantCommunicationAlarm
  End
End
```

It is possible to call a strategy from another strategy, thus “MotionDetection” invites the Strategy “LaunchDistantCommunicationAlarm” to start an external alarm.

It is possible to generate the strategies in an ergonomic way from a Web site, which avoids having to write the lines of macro manually.

In terms of use, the implementation of this technology has a great simplicity. The stages of this use are, for example, the following ones:

1) the installation of a security system requires having a WIFI access point or a box FREEBOX (trademark) or LIVEBOX (trademark), with subscription to an operator, on the site to be supervised.

2) According to the installation which one wishes to carry out, one takes on the market the most standardized available components of security, and thus the least expensive ones: in the example: Cameras, Detectors of intrusion, Siren, Fire detector.

3) One chooses the two modes of communication used as reference by the system, which will be, for example, the modes of communication WIFI and GSM (adapters to be inserted in each controller).

4) One installs the components of security at the suitable places and one connects a module controller manually, with each component of security.

5) From the internet, one connects to a dedicated website and one obtains instantaneously a security system which parameters automatically by default.

6) One can, on this website, configure all the specific parameters for each component (zones) as well as all the selected specific security strategies.

Thus, equipped with its own intelligence, and with a global intelligence system, the system of security will apply a strategy of security defined by the care of the user. For example, the activation of a detector of intrusion could be controlled by the other sensors and, in the event of confirmation, it will start, for example, the activation of the siren of alarm, the activation of the camera, the recording of video images, the activation of the microphone, the sending of images and sounds to the website and/or to a fixed or mobile phone, the sending of SMS messages . . .

It is described, hereafter, the applications of the surveillance system object of the first aspect of this invention. Application to the surveillance of the children and of the old people remotely. The elements implemented are, for example:
Wifi Cameras and Network Cameras,
Wifi Microphones and Wifi phones,
Wifi or radio Pushbuttons and
ADSL/Wifi access point ensuring Internet connectivity.

Remotely, the consultation is carried out from a computer or a mobile phone and alarms SMS or MMS are sent at the time the user activates the emergency pushbutton.

Application to the surveillance of the house. The elements implemented are, for example:
Wifi Cameras and Network Cameras,
Wifi Microphones,
Wifi or wired perimetric and volumetric Detectors and
ADSL/Wifi access point ensuring Internet connectivity,

Remotely, the consultation is carried out from a computer or a mobile phone and, at the occurrence of an intrusion, alarms are sent by SMS, MMS, or by call on a mobile phone.

Application to the surveillance of people or buildings. The elements implemented are, for example:
Tiny Wifi or radio Cameras,
Tiny Wifi or radio Microphones,
ADSL/Wifi access point ensuring Internet connectivity and
Wifi/Radio Receiver located near the transmitters.

Remotely, the consultation is carried out from a computer or a mobile phone and listening can be also carried out at short range by means of a Wifi/Radio Receiver.

Application to the surveillance of the vehicles. The elements implemented are, for example:
Tiny network cameras,
Microphones,
Standard perimetric or volumetric Alarm and
external Network head GSM ensuring connectivity towards the network GSM/UMTS.

Remotely, the consultation is carried out from a computer or a mobile phone and a camera make it possible to look inside the vehicle and another one shows the environment thus allowing the localization of the vehicle.

Other applications relate to the security of the goods and the people, the remote surveillance of the old people, children, patients, the surveillance of industrial processes . . .

As understandable when reading the previous description, the setting implemented in the first aspect of this invention makes it possible to carry out an electronic surveillance system of second generation, in which each element has an embedded intelligence located in a microcontroller. The system is able to be reorganized, i.e. to change its structure and its leader, if one or more of the elements fail or become deteriorated. The system can be integrated simply into the domotic networks already in place in houses or buildings.

This surveillance system is upgradeable by update of the firmware, i.e. proprietary softwares specific to the microcontroller. It is, for example, possible to download an update making it possible to recognize a key sentence rather than numbers during authentication, without having to buy a new system.

The microcontrollers are increasingly powerful and incorporate more and more functions (RAM, ROM, EEPROM, analogic/numeric and numeric/analogic conversion). The implementation of the third aspect of this invention takes benefit from this power and this integration to obtain a unit miniaturized, cheap, and consuming a little quantity of energy.

According to alternatives of the process and device objects of the first two aspects of this invention:
the system can be improved with new functions by simple remote loading of software versions, for example in a version, the coding of the messages is carried out in 3DES, and a simple remote loading can make it possible to activate coding in AES;
one envisages activation by voice recognition: the system is equipped with a sensor of sound waves ready to carry out voice recognition. This function can be used to vocally order the activation or the deactivation of the system according to a code or a key sentence or by speech recognition of some authorized users;
the standard data-processing protocol SNMP can be used for the supervision of the system and the management of alarms, but other protocols can also be appropriate. For example, in the case of an implementation of the community leader and security strategies using JAVA, protocol RMI can replace SNMP for the transfer of information of supervision and alarm between the microcontrollers;
at least one actuator can be connected to each microcontroller, an actuator which can be a siren, a flash light, or a rolling shutter, a ventilator for smoke clearing, for example. These actuators are activated according to strategies of security defined in the system.

It is observed, in FIG. 6, a first mode of achievement of the third aspect of this invention, in the form of a unidirectional audio transmitter 600. This transmitter 600 is connected to a microphone 605 and contains, in an electronic circuit or transmitting audio/Wifi/internet module 610, a microphone preamplifier 615, a microcontroller 620, a bus PCMCIA (acronym of Personal Computer Memory Card international Association) 625 and one Wifi PCMCIA Adapter 630. The signals emitted by the Wifi PCMCIA Adapter 630 are received by an access point Wifi 635 and transmitted, via the Internet network 640, to a computer 645 equipped with loudspeakers 650.

Specifically, the electronic circuit 610 comprises a single integrated circuit consisting in a microcontroller 620.

In the particular mode of realization illustrated in FIG. 6, the microcontroller 620 is reprogrammable, for example it is a member of family PIC18F. It carries out itself the digitization of the audio signal coming from microphone 605, via the preamplifier 615 and controls the Wifi Adapter 630 from a PCMCIA or Compact Flash interface.

The Wifi signal resulting from the transmitting module 610 is collected by the Wifi Adapter 635 which is given the responsibility to route it towards the Internet 640. A computer 645 equipped with a reader RealPlayer or QuickTime can then play the received sound from Internet 640.

The transmitter illustrated in FIG. 6 presents an important miniaturization of its radio part, i.e. the transmitting module 610, while using standardized components and protocols. Moreover, the intelligence of the system is distributed between the microcontroller 620, which manages Internet protocols and the digitalization of the sound, and the Wifi Adapter 630, which manages the wireless transmission. The fact of using a microcontroller 620 of the family Microchip (trademark) PIC18F authorizes an increased and easy evolutivity of the functionalities of the wireless audio transmitter. This transmitting module 610 implements the protocols RTSP RTP/RTCP (acronym of Real Time Protocol/Real Time Control Protocol) with few components.

This compatibility with the Internet and multimedia standards makes it possible to implement the third aspect of this invention with simple multimedia readers such as RealPlayer and QuickTime rather than with proprietary softwares, which would have been the case if standardized protocols had not been used.

Microphone 605 consists of a simple electret transducer which already amplifies the signal by an internal transistor. The audio signals are then transmitted to the micro preamplifier 615 whose role is to amplify the signal before transmitting it to the microcontroller 620.

The micro preamplifier 615 is traditional: it includes only one transistor NPN BC548 polarized in voltage on its basis with a decoupling condensator.

Microcontroller 620, of type PIC18F452 of Microchip, has of a capacity of 32 Kbytes of ROM read-only memory and a dynamic read-write memory RAM of 1536 bytes. It has moreover eight analogical inputs and thirty four input-outputs ports. Microcontroller 620 uses eight lines of data to transmit or receive data towards the PCMCIA adapter and eleven lines of addresses. Moreover, there are six lines of control which make it possible to control the adapter or to receive information of control. In the case of the particular mode of realization illustrated in FIG. 6, one uses one analogical port on which is transmitted the pre-amplified audio signal.

Microcontroller 620 is connected to the Wifi Adapter 630 via a PCMCIA interface which makes it possible to connect Wifi PCMCIA Adapters or compact flash (trademark) via a converter. With regard to the WIFI interface, the mode of realization illustrated in FIG. 6 is compatible with the chipset WIFI PRISM II of Intersil (trademark) and functions with printed circuit boards using this chipset.

The functions necessary to the communication between microcontroller 620 and the chipset PRISM II are implemented on the basis of technical documentation describing the firmware “PRISMII”.

With regard to the Internet stack of protocols, the module of audio transmission implements the following Internet protocols:
ARP (acronym of Address Resolution Protocol) for the resolution of addresses,
IP (acronym of Internet Protocol),
ICMP (acronym of Internet Control Message Protocol),
UDP (acronym of Universal Datagram Protocol),
TCP (acronym of Transmission Control Protocol),
HTTP (acronym of Hypertext Transfer Protocol),
RTSP and
RTP/RTCP.

Given that the memory capacity is reduced in the microcontroller, only a simplified implementation of these protocols is carried out in the mode of realization illustrated in FIG. 6. This reduced and optimized stack of protocols is represented in FIG. 7 which shows the way in which the protocol layers are organized.

With regard to the power part, the transmitter can be powered by a 9 volts battery. Most of the energy is consumed by the Wifi adapter. Any other type of regulated power providing 9 Volts can be appropriate.

With regard to the implementation of the third aspect of this invention, a transmitter was tested successfully by using a Wifi Adapter Netgear (trademark) MA401 and a Wifi Adapter Inventel Airline (trademark) SN11P, each one of these adapters being equipped with the Chipset PRISM II (Trademark).

The communication towards Internet is carried out through a Wifi access point. In the tested mode of realization, this access point is an access point AP1200 from Cisco (trademark) but any other Wifi 802.11B router can be used.

It is observed that, in an alternative of the third aspect of this invention, the Wifi communication can use the “Ad hoc” mode rather than the Infrastructure mode. In this case, the communication is carried out into point-to-point with a recipient located at short range, and a Wifi Adapter gateway is not necessary anymore.

The computers connected to the access point at the same time as the module of audio transmission communicate with this module as soon as they support the protocols described previously.

To be able to listen to the audio flow from another computer, it is enough to have installed a multimedia reader which implements protocols RTSP and RTP/RTCP. In the mode of realization tested, listening works with readers such as RealPlayer or QuickTime. The current WindowsMedia reader (trademark) does not support RTP but only MMS (trademark); it cannot thus read audio flows in this particular example of realization. An alternative of the third aspect of this invention can however support MMS by an extension of the program stored in the microcontroller.

One observes, in FIG. 7, at the base of this stack of protocol layers, the PCMCIA interface, then, while going up, the standard 802.11b/802.3, the MAC layer, layer LLC/SNAP, standards IP and ARP, standards TCP, UDP and ICMP, then standards HTTP, RTSP and RTP/RTCP and, at the highest level, standards HTML, SDP and codec PCM-uLaw.

It is observed that standards HTTP and HTML are not used, in this mode of realization, to know if a distant user listens to the audio flow, so that a website could eventually dynamically configure the transmitter object of the third aspect of this invention. These standards are thus optional for the implementation of the third aspect of this invention.

With regard to the encoding of the sound, this one is encoded with format PCM-uLaw, which is a widely deployed format. It corresponds to profile 0 in the list of the video audio profiles. Flow is sampled at a frequency of 8 KHz, which means a sample takes place every 125 microseconds.

The operations done by the software module of the microcontroller 620 are illustrated in FIG. 8.

One observes, in FIG. 8, a stage of initialization of the system 805 which is carried out just after the power-up. During this stage 805, microcontroller 620 launches the “main” function, which carries out the following tasks:
initialization of the input-outputs ports,
initialization of the driver PCMCIA driver by a call to the function “PCMCIA_Init”.

This function detects the presence of the PCMCIA adapter, carries out one software initialization (“Software Reset”) of this adapter, and activates the Input/Output mode,
initialization of the driver WIFI/PRISMII in mode “Station” by a call to the function “PRISMII_Init_STA”. This function initializes the PRISMII firmware, allocates the buffer memories of transmission, and initializes the MAC address (acronym of Machine Address Code) of the Wifi adapter (in the example, the MAC address has as a value 00:34:56:78:9A:BC).

After the initialization of the transmitting audio module 610, the microcontroller 620 associates it to the access point Wifi 635, stage 810. In the example illustrated in FIGS. 6 to 8, the transmitting module 610 wants to join the SSID (acronym Service Set IDentifier) target “tsunami”.

The transmitting module 610 carries out initially a research of the available SSIDs by means of the function “Scan”. Once the target SSID is detected, the transmitting module 610 launches the procedure of association by means of the function “Join”.

If the operation of association proceeded well, the audio transmitting module is able to transmit and receive packets of data. After association, the “main” function enters in an infinite loop which scans the buffer memory “buffer” of reception of the Wifi Adapter 630, stage 815, by means of the function “WaitRx”. This function returns “true” if a packet was received, if not “false”.

With regard to the treatment of protocols ARP, ICMP and TCP, stage 835 which is carried out if a packet was received, the treatment of this packet is given to the function “ProcessRx”. This function extracts initially the header “LLC/SNAP” of the packet and checks that it is indeed an IP or ARP packet addressed to the audio transmitter. If it is not the case, the packet is destroyed.

In the event of reception of an IP packet (code LLCSNAP/PID 0×800), the function “ProcessRx” tests if it is a TCP packet, stage 840.

If the IP packet is of type ICMP (acronym of Internet Control Message Protocol), the function “ProcessRx” sends an answer to the sender by calling the function “SendICMPReply”, stage 845. If the packet is of type ARP (code LLCSNAP/PID 0×806), the function “ProcessRx” sends a response by calling the function “SendARPReply”, stage 845. Then, we go back to stage 815.

If the packet is of type TCP, the function “ProcessRx” tests initially if it is a HTTP or RTSP packet, stage 850. If it is not the case, the packet is destroyed, and one returns to stage 815. According to the transmitter of the packet, the source port, and the destination port, the ProcessRx function determines if a session TCP was already opened and modifies the parameters of this session, or initializes a new TCP session.

The packet and the number of the TCP session are then transmitted to the function “ProcessTCPPacket”. This function deals with the TCP state-machine and thus manages the signals of synchronization TCP-SYN, of acknowledgement TCP-ACK, and the function of end of communication TCP-FIN.

If the packet is HTTP, during a stage 855, the function “ProcessTCPPacket” evaluates the “GET” chain received by the audio transmitter and answers by sending an answer HTTP followed by a Web page written in HTML (the Web page of the site contained in the memory of the microcontroller posts for example an information indicating if a customer already listening to the flow, or audio stream is connected: this connection is the result of a negotiation between the two partners according to protocol RTSP). Then one returns to stage 815.

If the packet is RTSP, for the treatment of the protocol RTSP, during the stage 860, the function “ProcessTCPPacket” evaluates the character string received by the audio transmitter and answers by sending an RTSP answer adapted to the RTSP request. The supported key words are “OPTIONS”, “DESCRIBE”, “SETUP”, “PLAY” and “TEARDOWN” (these key words are described precisely in standard IETF RFC 2326 which describes the RTSP protocol).

During the stage 865, one determines if the received RTSP chain is the word “PLAY”. If not, during the stage 870, the function “ProcessTCPPacket” sends an adequate RTSP answer and returns to stage 815. With regard to this sending of an RTSP answer, during the request “DESCRIBE”, the audio transmitter sends an answer using the SDP protocol, by in particular filling the fields “version”, “media”, “control”. At the time of request “SETUP”, the transmitter gets the address of the client ports RTP and RTCP, and sends in return its own ports RTP and RTCP (4096 and 4097 in the implementation of the prototype).

If the received RTSP chain is the word “PLAY”, the sending of audio packets can begin after memorizing the recipient address, stage 875 and one returns to stage 870. The transmitter considers that the sending of audio packets RTP/UDP towards the receiver can begin. The address IP and ports RTP and RTCP of the recipient are memorized. The function “ProcessTCPPacket” sends the RTSP answer, stage 870 and exits with the return code 0×11 to indicate the beginning of the transmission of the audio packets. The “main” function activates then the interruption timers with a frequency of 8000 Hz which means periods of 125 microseconds.

If the result of stage 815 is negative, i.e. if no packet were received, during the stage 820, one launches the RTP/RTCP audio treatment and the “main” function calls this treatment in its infinite loop. Each time the turning memory buffer is filled, the contents of the turning memory buffer are transferred to a memory buffer of RTP transmission after being converted with the coder-decoder (or codec)“PCM-ULaw”.

Then, during the stage 825, one tests the presence of a RTP/RTCP audio recipient: if a RTP/RTCP recipient is identified (code 0×11 returned by the function “ProcessTCPPacket”), the sending of the packet can start, if not, one returns to the infinite loop, stage 815.

During the sending of a packet UDP/RTP, stage 830, the contents of the memory buffer of transmission are sent to the function “SndRTPPacket” whose role is to send the audio RTP packet towards the recipient via the Wifi connection. Packet RTP is completed with sequential and temporal information (by the function “TimeStamps”) allowing the receiver to know how to schedule the received packets. Then one returns to stage 815.

At the time of an interruption from the “timer” clock, stage 880, this interruption being activated by the “main” function when a recipient RTP/RTCP is identified, the microcontroller 620 jumps to the interruption routine “clock_isr” and returns to the main program at stage 815 at the end of the routine of interruption. The microcontroller generates interruption “TIMER0 automatically” as soon as the counter “TIMER0” reaches zero. It is thus necessary to reinitialize this counter in the routine of interruption so that a new interruption can be generated.

With regard to the analogic/numeric conversion, stage 885, in addition to the initialization of the counter “TIMER0”, the function “clock_isr” receives the result of the analog-to-digital conversion on port AN0. This conversion takes approximately 20 microseconds, which remains compatible with the sampling rate of 8000 Hz which requires a measurement every 125 microseconds.

Then, during a stage 890, one proceeds to the writing in the turning memory buffer, once audio sampling is carried out, the result of the conversion being registered in the turning memory buffer. The index of the memory buffer is incremented to prepare the next writing. The routine of interruption can then return back to the main program.

In the second mode of realization illustrated in FIGS. 9 to 11B and adapted to the wireless telephony on Internet, the microcontroller is, for example, of type PIC18F452, family MICROCHIP PIC18F (trademark). It handles itself the digitization of the sound as well as the management of the Wifi adapter from the PCMCIA interface. It also sends the sound towards loudspeakers thanks to its interface PWM (acronym of Pulsates Width Modulation).

The Wifi signal from the phone transmitter is collected by a Wifi access point which is given the responsibility to relay it towards the Internet. A computer equipped with a software package implementing the

H323 standard like “NetMeeting” or “openphone” (trademarks) can then play the sound received from Internet and answer to it in an interactive way.

One of the interests of this mode of realization resides in its great tinyness and its evolutivity while using usual components and standardized protocols of wireless transmission and voice over IP. Moreover, the intelligence of the system is distributed between the microcontroller which manages Internet protocols, the sampling/desampling of the sound and the Wifi adapter which manages the wireless transmission. The fact of using a microcontroller of the family Microchip PIC18F authorizes an increased and easy evolutionarity of the functionalities of the phone transmitter, as well as a limited manufacturing cost. In addition, there are not such simple products which can implement the protocols of the H323 standard in a general-purpose microcontroller.

This compatibility with the Internet and multimedia standards makes it possible to implement the third aspect of this invention with software packages implementing the largely deployed H323 standard such as “Netmeeting” and “Openphone” rather than with proprietary softwares, which would have been the case if standardized protocols had not been used.

One observes, in FIG. 9, a phone transmitter 900 connected to a microphone 905 and which contains, in an electronic circuit or transmitter-receiver audio Wifi/Internet module 910, a preamplifier 915, a microcontroller 920, a PCMCIA bus 925, a PCMCIA Wifi Adapter 930, a low-pass filter stage 960 and one loudspeaker 965. The signals emitted by the PCMCIA Wifi Adapter 930 are received by an access point Wifi 935 and transmitted, via the data-processing Internet network 940, with a computer 945 containing loudspeakers 950. Inversely, the sounds collected at the computer level 945 by a microphone 955 are transmitted, via the computer 945 and the Internet 940 at the access point Wifi 935, where they are transmitted to the module 910.

In a characteristic way, the electronic circuit 910 comprises a single integrated circuit consisting in the microcontroller 920.

With regard to the stage loudspeaker, the sound output is carried out on pin PWM of the microcontroller 920, the width of the impulse being directly proportional to the tension of the signal to restore. The passive low-pass filter, for example with a RC network, 960 converts the signal from the width modulation pin PWM of microcontroller 920. The low-pass filter 960 has, for example, a band-width of −3 dB at 8000 Hz. The signal from filter 960 is then adapted in impedance by an impedance converter using a transistor BC548 (not represented).

After this adaptation of impedance, the signal is able to attack a loudspeaker 965 having an impedance higher or equal to 1 Kohms, which is compatible with the loudspeakers equipping the audio helmets.

With regard to the stage microcontroller, microcontroller 920 is of reprogrammable type, for example of type Microchip PIC18F452, has of a capacity of 32 Kbytes of ROM read-only memory and a dynamic read-write memory RAM of 1536 bytes. It has moreover eight analogical entries and thirty four input-outputs ports. In the mode of realization tested, one uses one analogical port on which is transmitted the pre-amplified audio signal.

To be able to answer the realtime constraints related to the interactivity, the microcontroller 920, for example is given a speed of 40 MHz, which makes it possible to obtain a calculation power of 10 MIPS.

Microcontroller 920 is connected to the Wifi Adapter 930 via a PCMCIA interface. This PCMCIA interface makes it possible to connect PCMCIA Wifi Adapters or compact flash via a converter. Microcontroller 920 uses eight lines of data to transmit or receive data towards the PCMCIA adapter and eleven lines of addresses. There are in addition six lines of control which make it possible to control the adapter or to receive control information.

With regard to the Wifi interface one implements the chipset Wifi PRISM II of Intersil.

With regard to the Power stage, the prototype was supplied by means of a 9 volts battery, having most of the energy consumed by the Wifi adapter.

Any other type of regulated 9 volts power can however be appropriate.

With regard to the implementation of the third aspect of this invention, a phone transmitter was tested successfully by using a Wifi Adapter Netgear MA401 (Trademark) and a Wifi Adapter Inventel Airline (Trademark) SN11P, each one of these boards being equipped with the Chipset PRISM II with Intersil (Trademark).

The communication towards Internet is carried out through an access point Wifi. In the case of the prototype, this access point is an AP1200 from Cisco (Trademark) but any other Wifi 802.11B router can be used.

The computers connected to the access point at the same time as the Wifi telephone using the microcontroller Microchip (trademark) can communicate with this module as soon as they support the H323 protocols described previously.

To be able to communicate in voice over IP with the Wifi telephone from another computer, it is enough to use a H323 software package such as Netmeeting delivered in a standard way under Windows or OpenPhone from a PC under Linux (trademark). At present the implementation of the third aspect of this invention was tested successfully by using these software packages.

With regard to the stack of Internet protocols, the module of audio transmission supports the following Internet protocols:
ARP for the resolution of address,
IP for Internet,
ICMP Internet message protocol,
UDP,
TCP,
HTTP,
H323 for the stack of protocol of voice over IP which includes:
   Q931,
   H225 with encoding ASN.1 PER,
   H245 with encoding ASN.1 PER and
   RTP/RTCP.

Only a reduced implementation of these protocols is implemented to be able to function in a very reduced memory capacity

This reduced and optimized stack of protocols is described, by the way in which the protocol layers are superimposed, in FIG. 10.

One observes, in FIG. 10, at the base of this stack of protocol layers, the PCMCIA interface, then, while going up, the standard 802.11b/802.3, the MAC layer, the layer LLC/SNAP, the standards IP and ARP, the standards TCP, UDP and ICMP, then the standards HTTP, H323 (comprising the standards Q931, H225 and H245) and RTP/RTCP and, at the highest level, the standards HTML and codec PCM-uLaw.

With regard to the encoding and the decoding of the sound, the telephone transmitter encodes and decodes the sound with the PCM-uLaw format. It corresponds to profile 0 in the list of the video audio profiles. Flow is sampled at a frequency of 8 KHz with a new sample every 125 microseconds. Specific algorithms are developed to support the codec PCM-uLaw in format of sample coded on 8 bits whereas the initial specification envisages samples of 16 bits. Indeed, microcontroller PIC18F452 comes with a technical limit of 10 bits for the sampling/desampling which, in the mode of realization described, required an adaptation of the codec.

The software module microcontroller is described in the FIGS. 11A and 11B.

The initialization of the system is carried out after powering, stage 1105. Microcontroller 920 launches the “main” function, which carries out the following tasks:
initialization of the input-outputs ports,
pre-filling of the header of RTP packets,
initialization of the PCMCIA driver by a call to the function “PCMCIA_Init”. This function detects the presence of a PCMCIA board, carries out a reset of the software (“Software Reset”) of this adapter, and activates the Input/Output mode,
initialization of the Wifi/PRISMII driver in mode “Station” by a call to the function “PRISMII_Init_STA”: this function initializes the firmware of the PRISMII, allocates the transmission buffer memories, and initializes the MAC address of the Wifi adapter (in our example, the MAC address has as a value 00:34:56:78:9A:BC).

Then, during a stage 1110, the microcontroller carries out the association of the telephone transmitter 900 with the access point Wifi 935. In our example the system seeks to join the SSID target “tsunami”. The telephone transmitter Wifi carries out initially a research of the available SSIDs by means of the function “Scan”. Once the target SSID is detected, the microcontroller launches the procedure of association by means of the function “Join”. If the operation of association proceeded well, the telephone transmitter Wifi is able to transmit and receive packets via the access point Wifi 935.

During the stage 1115, one carries out a test of packet reception, the “main” function returns in an infinite loop which scans initially the memory buffer of reception of the Wifi adapter by means of the function “WaitRx”. This function returns the value “true” if a packet was received, else it returns the value “false”.

If a packet was received, during the stage 1140, one carries out the treatment of the protocols ARP, ICMP, TCP and UDP, the treatment of the packet being handled by the function “ProcessRx”. This function extracts initially the LLC/SNAP header from the packet and checks that it is indeed a packet IP or ARP addressed to the Wifi telephone. If it is not the case, the packet is destroyed.

Then, during the stage 1145, one carries out a test to determine the type of received packet. If the packet is of type TCP, during the stage 1175, the function “ProcessRx” tests if it is a packet HTTP or H323 (which includes also the H245 packets which are part of the stack of H323 protocols). If it is not the case, the packet is destroyed. According to the transmitter of the packet, the port source, and the port destination, the function determines if a TCP session was already opened and modifies the parameters of this session, or initializes a new TCP session. The packet and the number of the TCP session are then transmitted to the function “ProcessTCPPacket”. This function treats the TCP state-machine and thus manages the signals of synchronization “TCP-SYN”, acknowledgement of delivery “TCP-ACK”, and of end of communication “TCP-FIN”.

If the packet is in conformity with the H323 standard, for the treatment of the protocol H323, the function “ProcessTCPPacket” evaluates the port of the TCP protocol, stage 1180.

If it is on the port H323 (1720), the function then carries out the treatment of the Q931 protocols, stage 1185 and H225, stage 1190. If it is on the H245 port, then the function “Opere” carries out the treatment of the protocol H245, stage 1195.

With regard to the treatment of the Q931 protocol, stage 1185, the function “ProcessTCPPacket” gets initially the reference number of the Q931 call and checks that it is indeed a packet “SETUP”. If it is the case, the ProcessTCPPacket function returns a packet Q931 “CONNECT” corresponding to the reference number of the phone call and adds information “Display” with for value “INCS”. Then information corresponding to the H225 protocol is added to the Q931 packet in the field “User-user”.

With regard to the treatment of the H225 protocol, stage 1190, the function “ProcessTCPPacket” adds H225 information to the Q931 packet under ASN.1 format with PER encoding. The field “H323_message_body” has “connect” for value. The field “H₂₄₅Address” has as for IP address, the address of the Wifi telephone, and the port of H245 communication is filled. The field “ConferenceID” is also filled. In addition, the field “H245 Tunneling” has as the value “false”, which means that the H245 packets will not be encapsulated in the H225 packets. The H225 packet encapsulated in the Q931 packet is then sent to the caller.

With regard to the treatment of the H245 protocol, stage 1195, initially, the function “ProcessTCPPacket” builds a table where are stored the parameters of the messages requests or answers sent by the caller as the fragmented H245 packets arrive on the H245 port. This operation requires a decoding of the packets coded in ASN.1 PER.

Once that caller has finished sending the fragments of packet, the treatment and the analysis of the messages and H245 answers can start.

In the case of a request of the type “MasterSlaveDetermination”, a response of the type “MasterSlaveDeterminationAck” with decision “master” is returned to the caller.

In the case of a request of the type “TerminalCapabilitySet”, a response of the type “TerminalCapabilitySetAck” with a number of sequence identical to the one of the request is returned. A request of the type “TerminalCapabilitySet” is added to the response returned to the caller. This request specifies that the Wifi telephone supports the codec G711 Ulaw, with packets RTP going up to 256 bytes.

In the case of a request of the type “OpenLogicalChannel”, a response of the type “OpenLogicalChannelAck” is returned with a “LogicalChannelNumber” identical to the request. The fields “MediaChannel” and “MediaControlChannel” are filled with the address IP and ports RTP/RTCP of the Wifi telephone.

In the case of a response of the type “MasterSlaveDeterminationAck”, the telephone transmitter Wifi returns to the caller a request of the type “OpenLogicalChannel”. The field “MediaControlChannel” of the request is filled with the RTCP port and IP address of the Wifi telephone.

In the case of a command of type “EndSessionCommand”, this command message indicates to the Wifi telephone that the H323 session must be completed. The function “ProcessTCPPacket” returns then a return code 0×12 indicating the completion of the H323 session and thus the stop of audio flows.

Then, during a stage 1200, one tests if the answer is of type “OpenLogicalChannelAck” (referring to “OpenLogAck” in the figure), in the function “ProcessTCPPacket”, this H245 message indicating that the H323 negotiation Is now completed. The sending and the reception of audio flows can then begin and one goes to the stage 1205. If not, one goes to the stage 1210.

For the addition of the RTP/RTCP recipient, stage 1205, if the received H323 message is “OpenLogicalChannelAck”, the telephone transmitter Wifi considers that the sending and the reception of audio packets RTP/UDP can begin. The address IP and ports RTP and RTCP of the recipient are memorized. The function “ProcessTCPPacket” exits with the return code 0×11 to indicate the beginning of the sending and the reception of the audio packets. The “main” function then activates the “timer” interruptions with a frequency of 8000 Hz which means 125 microseconds periods and returns in the loop of treatment common to audio flows and IP packets. Then one goes to the stage 1210.

During the stage 1210, which relates to the sending of a H323 answer, at the time of the negotiation H323, each message H323 or H245 received by the Wifi telephone results in a response respecting the H323 standard encoded using the ASN.1 PER format. Then one returns to the stage 1115.

If the stage 1145 determines that the packet is of type RTP, during a stage 1155, one tests the RTP packet: the function “ProcessRx” tests if it is a packet UDP, and then it checks that the destination port corresponds well to the RTP port of the Wifi telephone. If the received RTP packet has well, for source port, the RTP port of the RTP/RTCP sender resulting from the H323 negotiation, the treatment of the received audio packet can start. If not, one returns to the stage 1115. If it is the first audio packet, the program then calculates the size of the audio information contained in the packet, in order to correctly dimension the turning buffer memory of audio reception.

Then, during a stage 1160, the received audio flow is encoded according to the codec G711 Mu-Law. A rough decoding would give a series of samples coded on 16 bits, which is incompatible with the resolution of the PWM module of the microcontroller Microchip PIC18F452 limited to 10 bits. A specific algorithm of G711 Mu-Law decoding “ulaw2linear8” was thus developed to restore the sound samples with the 8 bits format.

Then, during the stage 1165, stage of writing in the turning buffer memory of reception, the turning buffer memory of reception is dimensioned with twice the size of the received audio packets. This doubling of the size makes it possible to compensate for the temporal shifts in the reception, which ensures a good acoustic comfort. After G711 Mu-Law decoding, the samples 8 bits are registered in the turning buffer memory of reception. The position of writing in the buffer memory is alternatively in first half or second half of the buffer memory progressively with the received packets. This alternative mode makes it possible to prevent that one registers samples in the part of the buffer memory buffer which is currently read by the routine of interruption.

If the stage 1175 determines that the packet is of type HTTP, during the stage 1170, stage of sending of an HTTP answer, the function “ProcessTCPPacket” evaluates the chain “GET” received by the audio transmitter and answers by sending an HTTP answer followed by a Web page written in HTML.

If the stage 1145 determines that the packet is neither RTP, nor TCP, during the stage 1150, stage of sending of an answer ARP, ICMP, if packet IP is of type ICMP, the function “ProcessRx” sends an answer to the sender by calling the function “SendICMPReply”. If the packet is of type ARP (code LLCSNAP/PID 0×806), the function “ProcessRx” sends a response by calling the function “SendARPReply”. Then, one returns to the stage 1115.

If the stage 1115 determines that no packet was received, during the stage 1120, one determines if a RTP session is active. If no session RTP is active, the “main” function returns to the stage 1115, and waits for the reception of a packet.

If a RTP session is active, one carries out, during the stage 1125, a treatment of audio emission RTP/RTCP, the “main” function calling this treatment in its infinite loop. For reasons of performance, this treatment takes place in three times according to the position of the index in the turning memory buffer of emission. If the index is null, the RTP packet of emission is initialized by calling the function “PrepareToSendRTPPacket”. This function configures sequential and temporal information (“TimeStamps”) allowing the receiver to know how to schedule the received packets. Then, progressively with their arrival, the sound samples are converted with the G711 Mu-Law format by calling the function “linear2ulaw8” and are registered within the RTP packet for emission. Then, once the index of emission reaches the size of the RTP packet, the RTP packet is sent towards the recipient resulting from the H323 negotiation.

Then, during a stage 1130, one carries out the G711 encoding during which the sound samples are encoded according to the codec G711 MU-Law. In the mode of realization described, a rough encoding would be inappropriate because it would be based on samples of 16 bits whereas the analogic/numeric converter included in the microcontroller Microchip PIC18F452 has a resolution limited to 10 bits. A specific algorithm of G711 Mu-Law encoding “linear2ulaw8” was thus developed for encoding the sound samples 8 bits with the format G711 Mu-Law.

Then, during the stage 1135, one sends a UDP/RTP packet, once the turning memory buffer of transmission is filled, the RTP packet being then sent to the recipient.

The number of sequence is incremented and the index of emission is re-initialized. Then, one returns to the stage 1115.

The FIG. 11B relates to the stages carried out in the event of interruption of clock (“timer”), stage 1215. This interruption is activated by the “main” function when a H323 session succeeded and that a recipient RTP/RTCP is thus identified. The microcontroller then jumps to the routine of interruption “clock_isr” and returns to the main program at the end of the routine of interruption. The microcontroller generates interruption “TIMER0” automatically as soon as counter “TIMER0” reaches zero. It is thus necessary to reinitialize this counter in the routine of interruption so that a new interruption can be generated.

During the stage 1220, one carries out the analogic/numeric conversion: in addition to the initialization of the counter “TIMER0”, the function “clock_isr” gets the result of the analog-to-digital conversion on port AN0. This conversion takes approximately 20 microseconds, which is compatible with the sampling rate of 8000 Hz which requires a measurement every 125 microseconds.

Then, during the stage 1225, one proceeds to the writing in the turning memory buffer of emission, once the audio sampling is carried out, the result of the conversion being written in the turning memory buffer of emission and the index of the buffer of emission being incremented to prepare the next writing.

During a stage 1230 of reading in the turning memory buffer of reception, the routine of interruption reads, memorizes, and erases the content of the turning memory buffer of reception located at the index of reading.

Then, during a stage 1235 of numeric/analogic PWM conversion, the value read in the turning memory buffer of reception is configured in the interface “PulseWidthModulation” of the microcontroller PIC18F452. Thus, a pulse proportional to the configured value is generated, which allows, after filtering, a sound restitution whose amplitude is proportional to the memorized numerical value. Then, the index of reading in the turning memory buffer of reception is incremented and the routine of interruption then returns to the main program.

In alternative, the program makes it possible to call someone and to enter in communication with him.

1. Remote surveillance system, characterized in that it contains:
at least two elements named “external network heads” containing, each one, at least:
a mean of communication at long distance.
a mean of wireless communicating at short range and.
a microcontroller and
at least one sensor adapted to emit, with a mean of wireless communicating at short range, a signal representative of a physical data and the aforementioned elements “external network heads” being adapted to communicate between them and with the aforementioned sensor, via their means of wireless communicating at short range, at least one of the aforesaid elements “external network heads” being adapted to communicate at long distance, via its mean of communication at long distance, according to the state of each other element “network head” and according to the signal provided by at least one sensor.

2. Surveillance system according to claim 1, characterized in that at least one of the elements named “network head” implement the data-processing protocol SNMP, for Simple Network Management Protocol.

3. Surveillance system according to claim 1, characterized in that at least one of the elements named “network head” contains a microcontroller including its own power adapter.

4. Surveillance system according to claim 1, characterized in that the elements of the security system are grouped into separated sets and, in each set, they are adapted to communicate with all the other elements of the aforesaid set.

5. Surveillance system according to claim 4, characterized in that in each set of elements, each element “network head” is adapted to become the leader of the aforesaid set of elements, i.e. to organize the communication with all the other elements of the aforesaid set of elements.

6. Surveillance system according to claim 1, characterized in that at least two elements “external network head” implement a different support for long-distance calls.

7. Surveillance system according to claim 1, characterized in that at least one of the elements “network head” is adapted to cipher messages.

8. Surveillance system according to claim 1, characterized in that at least one element “external network head” is adapted to being accessed at long distance and, when it is accessed at long distance, to transmit a request to each other element “network heads” of the system, in order to receive, as a response, the state and/or the information collected by of the aforesaid sensors of the other elements.

9. Surveillance system according to claim 1, characterized in that each sensor is associated to a mean of wireless communicating at short range.

10. Surveillance system according to claim 1, characterized in that at least one element “external network head” is adapted to transmit remotely an alarm, according to a signal resulting from a sensor.

11. Surveillance system according to claim 1, characterized in that at least one element “external network head” is adapted to transmit remotely a signal coming from a sensor.

12. Surveillance system according to claim 1, characterized in that at least one sensor is a sensor of image.

13. Surveillance system according to claim 1, characterized in that at least one sensor is a sensor of sound waves.

14. Surveillance system according to claim 13, characterized in that at least one sensor of sound wave is associated to a controller adapted to carry out a voice recognition.

15. Surveillance system according to claim 1, characterized in that at least one sensor contains a pushbutton.

16. Surveillance system according to claim 1, characterized in that at least one of the elements “external network head” is an ADSL and/or Wifi access point ensuring remote connectivity on the Internet network.

17. Surveillance system according to claim 1, characterized in that at least one of the elements “external network head” comprises an interface with a telephone network and is adapted to dial a telephone number.

18. Surveillance system according to claim 1, characterized in that at least one sensor is a perimetric and/or volumetric detector.

19. System of remote surveillance, characterized in that it comprises:
a stage of capture and treatment of a physical data,
a stage of wireless communicating at short range between an element named “network head” adapted to communicate at short range and one among a plurality of elements named “external network heads” adapted to communicate at short range and long distance,
a stage of long-distance call, carried out by one or the other of the elements named “external network head” according to the aforementioned wireless communicating at short range.
